(19) United States
(12) Patent Application Publication
(10) Pub. No.: US 2026/0105102 A1
(43) Pub. Date: Apr. 16, 2026

(54) Accelerated LLM Usage

(71) Applicant: Lasso Security Inc., Wilmington, DE (US)

(72) Inventors: Ophir Dror, Tel Aviv-Yaffo (IL); Jonathan Alexander, Groningen (NL)

(21) Appl. No.: 19/352,514

(22) Filed: Oct. 8, 2025

Related U.S. Application Data
(60) Provisional application No. 63/706,758, filed on Oct. 14, 2024.

(51) Int. Cl. G06F 16/903

(52) U.S. Cl. CPC G06F 16/90335

(57) ABSTRACT

A method for use with a large language model (LLM) running on an execution platform and configured to generate each output by passing input through a neural network in one or more forward passes includes passing, to the LLM, a query including a request to render a decision from multiple predefined decisions, instructing the execution platform to return, after a first one of the forward passes, a set of candidate intermediate outputs generated by the neural network during the first one of the forward passes and respective confidence levels of the candidate intermediate outputs, selecting one of the predefined decisions based on the candidate intermediate outputs and the confidence levels, and performing an action based on the selected predefined decision. Other embodiments are also described.

### CROSS-REFERENCE TO RELATED APPLICATIONS

The present application claims the benefit of U.S. Provisional Application 63/706,758, filed Oct. 14, 2024, entitled “Rapid classifier,” whose disclosure is incorporated herein by reference.

### FIELD OF EMBODIMENTS OF THE INVENTION

Embodiments of the present invention relate generally to machine learning, and specifically to large language models (LLMs).

### BACKGROUND

Large Language Models (LLMs) represent a class of artificial intelligence (AI) systems that have gained widespread adoption across various applications including text generation, translation, summarization, and conversational interfaces. These models are typically based on transformer architectures and are trained on vast datasets of text to learn patterns, relationships, and structures within natural language.

Typically, the operational mechanism of an LLM involves autoregressive token generation through neural-network layers to generate a coherent and contextually appropriate text output. This autoregressive process allows the LLM to build a response incrementally, with each newly generated token influencing the context for subsequent token-generation steps. In other words, an LLM typically produces output through successive token generation steps, where each step includes a single forward propagation (or “pass”) through the neural network architecture. At the conclusion of each forward pass, the model generates a probability distribution over possible next tokens based on the current context, and selects a token according to various sampling strategies. A single token may represent a word, subword, or character, depending on the tokenization scheme employed.

### SUMMARY

There is provided, in accordance with some embodiments of the present invention, a system for use with a large language model (LLM) running on an execution platform and configured to generate each output by passing input through a neural network in one or more forward passes. The system includes a network interface and a processor. The processor is configured to pass to the LLM, via the network interface, a query including a request to render a decision from multiple predefined decisions, to instruct the execution platform to return, after a first one of the forward passes, a set of candidate intermediate outputs generated by the neural network during the first one of the forward passes and respective confidence levels of the candidate intermediate outputs, to select one of the predefined decisions based on the candidate intermediate outputs and the confidence levels, and to perform an action based on the selected predefined decision.

There is further provided, in accordance with some embodiments of the present invention, a method for use with a large language model (LLM) running on an execution platform and configured to generate each output by passing input through a neural network in one or more forward passes. The method includes passing, to the LLM, a query including a request to render a decision from multiple predefined decisions. The method further includes instructing the execution platform to return, after a first one of the forward passes, a set of candidate intermediate outputs generated by the neural network during the first one of the forward passes and respective confidence levels of the candidate intermediate outputs. The method further includes selecting one of the predefined decisions based on the candidate intermediate outputs and the confidence levels, and performing an action based on the selected predefined decision.

In some embodiments, each of the candidate intermediate outputs corresponds to a different respective one of the predefined decisions, and selecting one of the predefined decisions includes selecting the predefined decision corresponding to the candidate intermediate output having a highest one of the confidence levels, relative to others of the candidate intermediate outputs.

In some embodiments, selecting one of the predefined decisions includes:
identifying one or more of the candidate intermediate outputs that correspond to respective ones of the predefined decisions; and
selecting the predefined decision corresponding to the identified candidate intermediate output having a highest one of the confidence levels, relative to others of the identified candidate intermediate outputs.

In some embodiments, selecting one of the predefined decisions includes:
identifying one or more groups of the candidate intermediate outputs corresponding to different respective ones of the predefined decisions;
based on the confidence levels, computing respective probabilities of the groups; and
selecting the predefined decision corresponding to the group having a highest one of the probabilities, relative to others of the groups.

In some embodiments, the action includes preventing an interaction between a user and another LLM.

In some embodiments, the query specifies respective single tokens corresponding to the predefined decisions, and the query requests the LLM to render the decision by selecting one of the single tokens.

In some embodiments, the method further includes instructing the execution platform to return the candidate intermediate output selected by the LLM at an end of the first one of the forward passes, and the selecting includes selecting the predefined decision corresponding to the candidate intermediate output selected by the LLM.

In some embodiments, the query further includes a segment including one or more example queries with respective ones of the predefined decisions.

In some embodiments, the method further includes caching key and value vectors for the segment during a first session in which the segment is used.

There is further provided, in accordance with some embodiments of the present invention, a computer software product for use with a large language model (LLM) running on an execution platform and configured to generate each output by passing input through a neural network in one or more forward passes, the product including a tangible non-transitory computer-readable medium in which program instructions are stored. The instructions, when read by a processor, cause the processor to pass, to the LLM, a query including a request to render a decision from multiple predefined decisions, to instruct the execution platform to return, after a first one of the forward passes, a set of candidate intermediate outputs generated by the neural network during the first one of the forward passes and respective confidence levels of the candidate intermediate outputs, to select one of the predefined decisions based on the candidate intermediate outputs and the confidence levels, and to perform an action based on the selected predefined decision.

The present invention will be more fully understood from the following detailed description of embodiments thereof, taken together with the drawings, in which:

### BRIEF DESCRIPTION OF THE DRAWINGS

FIG. 1 is a schematic illustration of a system for accelerated LLM usage, in accordance with some embodiments of the present invention;

FIG. 2 is a schematic illustration of a query passed to an LLM, in accordance with some embodiments of the present invention;

FIGS. 3A-C are schematic illustrations of different methods for rendering a decision based on candidate intermediate outputs, in accordance with some embodiments of the present invention; and

FIG. 4 is a flow diagram for a method for accelerated LLM usage, in accordance with some embodiments of the present invention.

### DETAILED DESCRIPTION

### Overview

Current LLM implementations face various challenges related to computational efficiency, response latency, and resource utilization. For example, the sequential token-generation process of an LLM can result in extended processing times, and the computational overhead associated with multiple neural-network passes can impact system performance and scalability.

Embodiments of the present invention address these challenges by providing techniques for accelerated LLM usage that significantly reduce response latency while maintaining decision accuracy. These techniques leverage the observation that for queries having a finite set of possible responses, such as queries requiring classification or binary decisions, useful information can be extracted from the neural network of an LLM after the first forward pass through the neural network, such that it is not necessary to wait for any additional forward passes.

In particular, in embodiments of the present invention, each query is constructed so as to specify a set of permissible responses, each of which typically consists of a single token. For example, for a yes/no decision, the query may instruct the LLM to return “Y” for yes or “N” for no. In response to the query, the LLM executes its first forward pass, resulting in a set of candidate intermediate outputs from which a single candidate is to be selected by the LLM. Typically, each of the candidates consists of a single token, though some of the candidates may be different from the permissible responses in the specified set, and the LLM may execute one or more additional forward passes even if the candidates include at least one of the permissible responses.

Following the first forward pass, the candidate intermediate outputs, along with their respective confidence levels, which are typically logit scores, are captured. One of the permissible responses is then selected based on the candidate intermediate outputs and confidence levels. For example, in some embodiments, the response corresponding to the candidate having the highest confidence level is selected.

Typically, a candidate can be identified as corresponding to a predefined response even when there is not an exact textual match. For example, the system may recognize variations in formatting, spacing, capitalization, and punctuation that commonly occur in LLM outputs. As a specific example, “Y” and “\nY” can be identified as variations of the predefined response “Y.”

As noted above, typically, each of the predefined responses is restricted to a single token. Since LLMs generate outputs one token at a time, this restriction increases the likelihood that the response to the query (or at least a variation thereof) will be present in the candidate intermediate outputs after the first forward pass. Moreover, this single-token constraint may facilitate the identification of those candidates that correspond to the predefined responses, given that variations in a single token (e.g., “Y” instead of the predefined response “Y”) are more readily recognized, relative to multi-token variations.

By using the techniques described herein, embodiments of the present invention achieve response times that are substantially faster than those in conventional LLM usage. Hence, the disclosed embodiments are particularly advantageous in scenarios where quick policy decisions are needed, such as in content filtering, access control, or compliance checking.

### System Description

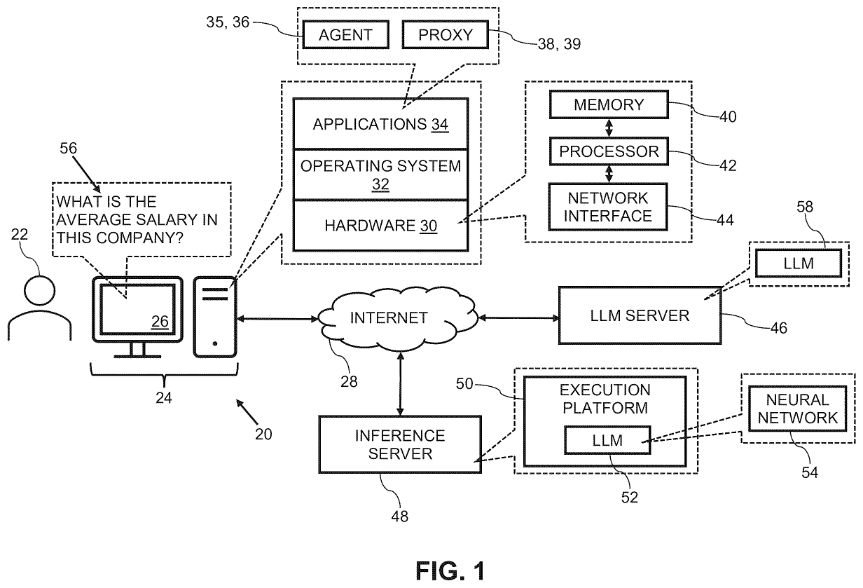

Reference is initially made to FIG. 1, which is a schematic illustration of a system 20 for accelerated LLM usage, in accordance with some embodiments of the present invention.

By way of example, FIG. 1 depicts a user 22, who is an employee of an organization, using a computer 24 of the organization to query an LLM 58 running on an LLM server 46. Computer 24 comprises hardware 30, which comprises a memory 40, such as a random access memory, a processor 42, and a network interface 44. Hardware 30 supports an operating system 32, which in turn supports applications 34, which processor 42 runs by loading program instructions into memory 40. In some embodiments, applications 34 comprise an LLM-based application 35, such as an AI agent 36, configured to interface with LLM 58. Alternatively, application 35 is installed on a server remote from computer 24 and is accessed, by user 22, via a user interface such as a web browser.

To query LLM 58, user 22 inputs, to application 35, a prompt 56, which is typically displayed on a monitor 26 of computer 24. Application 35 passes prompt 56, e.g., via network interface 44, to LLM server 46 via a computer network 28, such as the Internet. LLM 58 then generates a response to the prompt, and the response is then passed back to application 35 over network 28. Application 35 then displays the response on monitor 26.

In this example scenario, the organization may wish to prevent interactions between user 22 and LLM 58 that violate certain predefined policies. For example, the organization may wish to prevent the user from submitting a prompt that requests privileged information, such as salary-related information. Alternatively or additionally, even if such a prompt is submitted, the organization may wish to prevent the user from receiving a response to the prompt from LLM 58.

To address this scenario, system 20 comprises a module 38 configured to submit prompt 56, and/or the response to the prompt received from LLM 58, to another LLM 52, which comprises a neural network 54 and is configured to generate each output by passing input through neural network 54 in one or more forward passes. LLM 52 runs on an execution platform 50, which is typically installed on a separate server 48 referred to in FIG. 1 as an “inference server.”

In particular, module 38 submits a query including a request to decide whether the prompt from user 22, or the response from LLM 58, violates one of the predefined policies, where the decision is to be drawn from multiple predefined decisions, such as from a set of decisions consisting of “Yes” and “No.” Advantageously, by structuring the query in this way and by using execution platform 50 as described below, module 38 derives the decision in less time than it would take LLM 52 to respond normally. Based on the decision, module 38 may prevent an interaction between user 22 and LLM 58. For example, the module may prevent the prompt from reaching LLM 58 or prevent the response of LLM 58 from being displayed to the user.

In some embodiments, module 38 communicates directly with server 48 over network 28. In other embodiments, module 38 communicates with server 48 (and hence, with LLM 52) via an AI agent (not shown) running on another server.

Typically, module 38 is implemented in software executed on computer 24 (as depicted in FIG. 1), on LLM server 46, or on a separate server. In some embodiments, module 38 comprises a proxy (or “man-in-the-middle”) 39 that interposes between application 35 and LLM 58, such that all communication between application 35 and LLM 58 passes through module 38. Before passing prompt 56 to LLM 58, and/or before passing the response of LLM 58 to application 35, module 38 queries LLM 52 as described above.

Alternatively, for some embodiments in which application 35 is remote and is accessed by user 22 via a user interface, proxy 39 interposes between the user interface and application 35. Before passing prompt 56 to application 35, and/or before passing the response of LLM 58 to the user interface, module 38 queries LLM 52 as described above.

As yet another alternative, in some embodiments, instead of module 38 intercepting communication to or from application 35, application 35 is configured to communicate directly with module 38. Before passing prompt 56 to LLM 58, and/or before allowing the response of LLM 58 to be displayed on monitor 26, application 35 passes the prompt or response to module 38. Module 38 then queries LLM 52 as described above. If module 38 then decides, based on the querying, that the interaction is allowable, the module returns the prompt or response to application 35, and the application then proceeds with the interaction.

Alternatively to the scenario depicted in FIG. 1, system 20 can be used in any scenario in which a decision is to be drawn from multiple predefined decisions. For example, in some embodiments, system 20 is used for classification, such as for classifying text by assigning, to each text, a class drawn from a predefined set of classes. Example applications of such classification include content filtering, access control, compliance checking, anomaly detection, and sentiment analysis. In such embodiments, system 20 does not necessarily comprise application 35, and LLM 58 is not necessarily used. Rather, user 22 (or an automated agent) can prompt module 38 directly, and module 38 can then use LLM 52 to generate a rapid response.

In general, processor 42 may be embodied as a single processor, or as a cooperatively networked or clustered set of processors. Typically, processor 42 is embodied as a programmed processor comprising, for example, a central processing unit (CPU) and/or a Graphics Processing Unit (GPU). Program instructions, including software programs, and/or data are loaded for execution and processing by the CPU and/or GPU. The program instructions and/or data may be downloaded to the processor in electronic form, over a network, for example. Alternatively or additionally, the program instructions and/or data may be provided and/or stored on non-transitory tangible media, such as magnetic, optical, or electronic memory. Such program instructions and/or data, when provided to the processor, produce a machine or special-purpose computer configured to perform the tasks described herein.

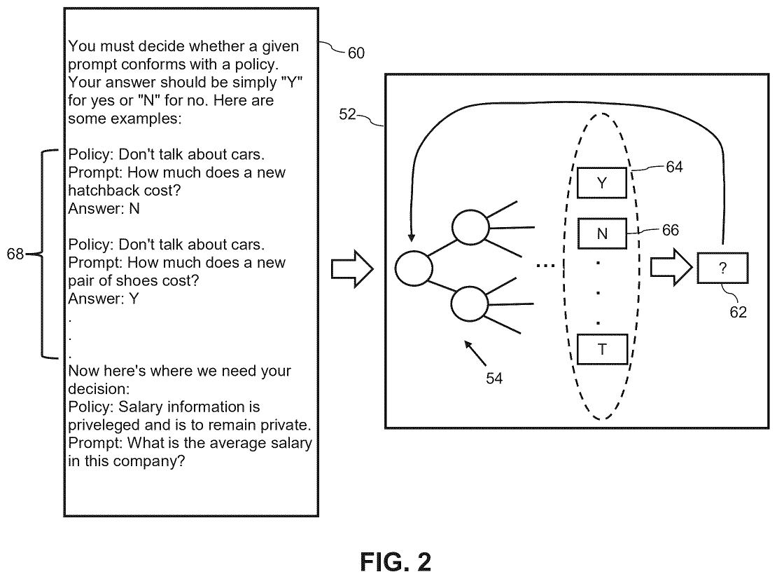

Reference is now additionally made to FIG. 2, which is a schematic illustration of a query 60 passed to LLM 52 by module 38, in accordance with some embodiments of the present invention.

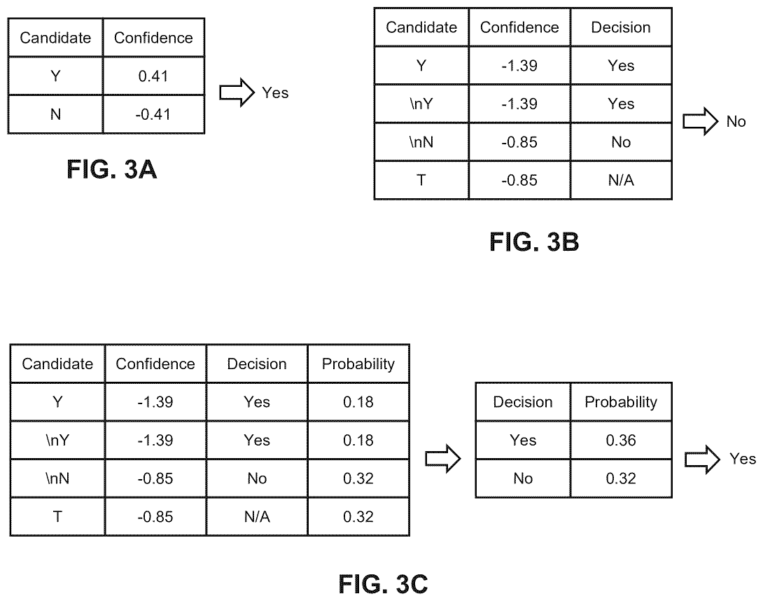

Query 60 includes a request to render a decision from multiple predefined decisions. After the query is passed to LLM 52, the LLM inputs the query to neural network 54. When used conventionally, the inputting of a query initiates an autoregressive process in which, following each forward pass through neural network 54, the LLM selects an intermediate output 62 from a set 64 of candidate intermediate outputs 66, each of which typically consists of a single token, generated by the neural network during the forward pass, and then passes intermediate output 62 back into the neural network as input for the next forward pass. However, to expedite a response to the query, module 38 instructs execution platform 50 to return set 64, along with respective confidence levels, such as respective logit scores, of candidate intermediate outputs 66, after the first forward pass. Module 38 then selects one of the predefined decisions based on the candidate intermediate outputs and the confidence levels, as further described below with reference to FIGS. 3A-C.

Typically, the query specifies respective single tokens corresponding to the predefined decisions, and requests the LLM to render the decision by selecting one of these predefined single tokens. For example, in the example of FIG. 2, the single tokens corresponding to the predefined decisions “Yes” and “No” are “Y” and “N,” respectively. As another example, the query may instruct the LLM to return “A” if the user is entitled to certain information, “B” if the user is entitled only with a manager's approval, or “C” if the user is not entitled at all. Advantageously, requesting that the LLM return a single token increases the probability that a response to query 60 can be derived from candidate intermediate outputs 66 after only a single forward pass. (Notwithstanding the above, if the execution platform were not instructed to return set 64, and instead the module were to wait for LLM 52 to finish execution normally, the LLM might execute multiple forward passes, despite having been requested to return a single token.)

In some embodiments, query 60 further includes a segment 68 including one or more example queries with respective ones of the predefined decisions. Advantageously, the inclusion of segment 68 increases the probability that a response to query 60 can be derived from candidate intermediate outputs 66 after only a single forward pass.

Typically, segment 68 is static, i.e., is the same across multiple queries. Hence, in some embodiments, module 38 is configured to cache key and value vectors for segment 68 during the first session in which the segment is used, thereby decreasing the time required for LLM 52 to process the segment.

In some embodiments, in addition to instructing execution platform 50 to return set 64, module 38 instructs the execution platform to terminate the output-generation process of LLM 52. Thus, in addition to the decision being expedited, significant computing resources are saved. In other embodiments, the LLM continues executing normally despite set 64 already having been returned. The final output of the LLM is then used offline (e.g., to improve the performance of module 38) or is simply ignored.

Reference is now additionally made to FIGS. 3A-C, which are schematic illustrations of different methods for rendering a decision based on candidate intermediate outputs 66, in accordance with some embodiments of the present invention. Each of FIGS. 3A-C corresponds to a scenario in which the set of predefined decisions consists of “Yes” and “No.”

In some embodiments, as in FIG. 3A, each of the candidate intermediate outputs corresponds to a different respective one of the predefined decisions. For example, in some embodiments, given any prompt that specifies a number of permissible outputs, execution platform 50 is configured to filter out any candidate intermediate outputs that do not lead to one of the permissible outputs. Hence, given that query 60 specifies a number of permissible outputs (e.g., tokens), each candidate intermediate output in set 64 corresponds to a different respective one of the predefined decisions. In such embodiments, module 38 selects the predefined decision corresponding to the candidate intermediate output having the highest confidence level. In the example shown in FIG. 3A, the candidate intermediate output having the highest confidence level is “Y,” and so the module selects the decision “Yes” corresponding to this candidate.

In other embodiments, as in FIGS. 3B-C, some of the candidate intermediate outputs in set 64 may not exactly match the permissible outputs (e.g., tokens) specified in the query.

In some such embodiments, module 38 first identifies any of the candidate intermediate outputs that correspond to respective ones of the predefined decisions. For example, in FIG. 3B, the module identifies “Y,” “\nY,” and “\nN.” Next, the module selects the predefined decision corresponding to the identified candidate intermediate output having the highest confidence level, relative to the other identified candidate intermediate outputs. For example, in FIG. 3B, in response to “\nN” having the highest confidence level, the module selects the corresponding decision “No.”

In other such embodiments, the module identifies one or more groups of the candidate intermediate outputs corresponding to different respective ones of the predefined decisions. For example, in FIG. 3C, the module assigns “Y” and “\nY” to a group corresponding to the “Yes” decision, and “\nN” to another group corresponding to the “No” decision. Next, based on the confidence levels, the module computes the respective probabilities of the groups. For example, FIG. 3C assumes that each i^{th} confidence level is a logit score zᵢ, such that the module first converts each confidence level to a probability Pᵢ by applying the formula

$${P}_{i} = \frac{{e}^{{z}_{i}}}{Σ {e}^{{z}_{j}}} ,$$

and then computes the probability of each group by summing the probabilities of the candidates in the group. Finally, the module selects the predefined decision corresponding to the group having the highest probability, which, in FIG. 3C, is “Yes.”

In general, to identify a correspondence between a candidate and a decision even if the candidate does not exactly match one of the permissible outputs (e.g., tokens) specified in the query (e.g., to identify that “\nN” is a variation of “N,” and hence corresponds to “No”), the module may use any suitable pattern-matching algorithm.

In some embodiments (though, typically, not those embodiments in which the candidates are grouped as in FIG. 3C), module 38 further instructs the execution platform to return the intermediate output 62 that follows the first forward pass, i.e., to return the candidate intermediate output selected by the LLM at the end of the first forward pass. Provided that intermediate output 62 corresponds to one of the predefined decisions, the module selects the predefined decision corresponding to intermediate output 62. The other candidates are considered only if candidate intermediate output 62 does not correspond to any of the predefined decisions. Advantageously, such embodiments may provide even greater time savings.

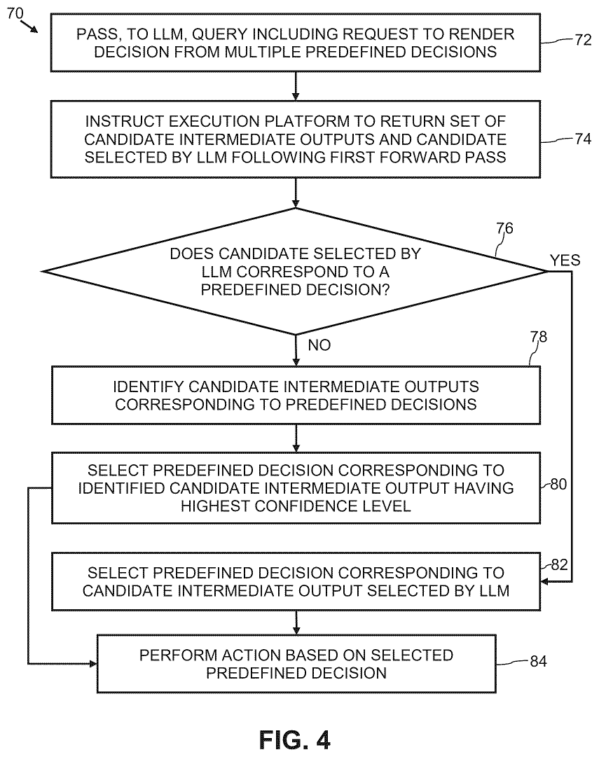

Reference is now additionally made to FIG. 4, which is a flow diagram for a method 70 for accelerated LLM usage, in accordance with some embodiments of the present invention.

At a query-passing step 72, module 38 passes, to LLM 52, a query including a request to render a decision from multiple predefined decisions. Next, at an instructing step 74, the module instructs execution platform 50 to return set 64 of candidate intermediate outputs 66, along with the candidate intermediate output selected by the LLM following the first forward pass. The module then checks, at a checking step 76, whether the candidate intermediate output selected by the LLM corresponds to one of the predefined decisions. If yes, the module, at a selecting step 82, selects the predefined decision corresponding to the candidate intermediate output selected by the LLM. Otherwise, the module, at a candidate-identifying step 78, identifies those candidate intermediate outputs that correspond to the predefined decisions, as in FIG. 3B. Subsequently, at another selecting step 80, the module selects the predefined decision corresponding to the identified candidate intermediate output having the highest confidence level, as in FIG. 3B.

Following selecting step 80 or selecting step 82, the module, at an action-performing step 84, performs an action based on selected predefined decision. For example, in some embodiments, the module prevents an interaction between user 22 and LLM 58. Alternatively or additionally, for example, the module displays the decision on monitor 26, processes or modifies a file based on the decision, and/or saves the decision to memory 40 and/or to a storage device such as a hard drive, solid-state drive, or flash drive.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

I claim:

1. A system for use with a large language model (LLM) running on an execution platform and configured to generate each output by passing input through a neural network in one or more forward passes, the system comprising:
a network interface; and
a processor, configured to:
pass to the LLM, via the network interface, a query including a request to render a decision from multiple predefined decisions,
instruct the execution platform to return, after a first one of the forward passes, a set of candidate intermediate outputs generated by the neural network during the first one of the forward passes and respective confidence levels of the candidate intermediate outputs,
select one of the predefined decisions based on the candidate intermediate outputs and the confidence levels, and
perform an action based on the selected predefined decision.

2. The system according to claim 1, wherein the query specifies respective single tokens corresponding to the predefined decisions, and wherein the query requests the LLM to render the decision by selecting one of the single tokens.

3. A method for use with a large language model (LLM) running on an execution platform and configured to generate each output by passing input through a neural network in one or more forward passes, the method comprising:
passing, to the LLM, a query including a request to render a decision from multiple predefined decisions;
instructing the execution platform to return, after a first one of the forward passes, a set of candidate intermediate outputs generated by the neural network during the first one of the forward passes and respective confidence levels of the candidate intermediate outputs;
selecting one of the predefined decisions based on the candidate intermediate outputs and the confidence levels; and
performing an action based on the selected predefined decision.

4. The method according to claim 3, wherein each of the candidate intermediate outputs corresponds to a different respective one of the predefined decisions, and wherein selecting one of the predefined decisions comprises selecting the predefined decision corresponding to the candidate intermediate output having a highest one of the confidence levels, relative to others of the candidate intermediate outputs.

5. The method according to claim 3, wherein selecting one of the predefined decisions comprises:
identifying one or more of the candidate intermediate outputs that correspond to respective ones of the predefined decisions; and
selecting the predefined decision corresponding to the identified candidate intermediate output having a highest one of the confidence levels, relative to others of the identified candidate intermediate outputs.

6. The method according to claim 3, wherein selecting one of the predefined decisions comprises:
identifying one or more groups of the candidate intermediate outputs corresponding to different respective ones of the predefined decisions;
based on the confidence levels, computing respective probabilities of the groups; and
selecting the predefined decision corresponding to the group having a highest one of the probabilities, relative to others of the groups.

7. The method according to claim 3, wherein the action includes preventing an interaction between a user and another LLM.

8. The method according to claim 3, wherein the query specifies respective single tokens corresponding to the predefined decisions, and wherein the query requests the LLM to render the decision by selecting one of the single tokens.

9. The method according to claim 3, further comprising instructing the execution platform to return the candidate intermediate output selected by the LLM at an end of the first one of the forward passes, wherein the selecting comprises selecting the predefined decision corresponding to the candidate intermediate output selected by the LLM.

10. The method according to claim 3, wherein the query further includes a segment including one or more example queries with respective ones of the predefined decisions.

11. The method according to claim 10, further comprising caching key and value vectors for the segment during a first session in which the segment is used.

12. A computer software product for use with a large language model (LLM) running on an execution platform and configured to generate each output by passing input through a neural network in one or more forward passes, the product comprising a tangible non-transitory computer-readable medium in which program instructions are stored, which instructions, when read by a processor, cause the processor to:
pass, to the LLM, a query including a request to render a decision from multiple predefined decisions,
instruct the execution platform to return, after a first one of the forward passes, a set of candidate intermediate outputs generated by the neural network during the first one of the forward passes and respective confidence levels of the candidate intermediate outputs,
select one of the predefined decisions based on the candidate intermediate outputs and the confidence levels, and
perform an action based on the selected predefined decision.

13. The computer software product according to claim 12, wherein each of the candidate intermediate outputs corresponds to a different respective one of the predefined decisions, and wherein the instructions cause the processor to select the predefined decision corresponding to the candidate intermediate output having a highest one of the confidence levels, relative to others of the candidate intermediate outputs.

14. The computer software product according to claim 12, wherein the instructions cause the processor to select one of the predefined decisions by:
identifying one or more of the candidate intermediate outputs that correspond to respective ones of the predefined decisions, and
selecting the predefined decision corresponding to the identified candidate intermediate output having a highest one of the confidence levels, relative to others of the identified candidate intermediate outputs.

15. The computer software product according to claim 12, wherein the instructions cause the processor to select one of the predefined decisions by:
identifying one or more groups of the candidate intermediate outputs corresponding to different respective ones of the predefined decisions,
based on the confidence levels, computing respective probabilities of the groups, and
selecting the predefined decision corresponding to the group having a highest one of the probabilities, relative to others of the groups.

16. The computer software product according to claim 12, wherein the action includes preventing an interaction between a user and another LLM.

17. The computer software product according to claim 12, wherein the query specifies respective single tokens corresponding to the predefined decisions, and wherein the query requests the LLM to render the decision by selecting one of the single tokens.

18. The computer software product according to claim 12, wherein the instructions further cause the processor to instruct the execution platform to return the candidate intermediate output selected by the LLM at an end of the first one of the forward passes, and wherein the instructions cause the processor to select the predefined decision corresponding to the candidate intermediate output selected by the LLM.

19. The computer software product according to claim 12, wherein the query further includes a segment including one or more example queries with respective ones of the predefined decisions.

20. The computer software product according to claim 19, wherein the instructions further cause the processor to cache key and value vectors for the segment during a first session in which the segment is used.
